(19) United States
(12) Patent Application Publication
(10) Pub. No.: US 2012/0137981 A1
(43) Pub. Date: Jun. 7, 2012

(54) Easiest and simplest animal lavatory

(76) Inventor: Paul F. Weissberg, Seaford, NY (US)

(21) Appl. No.: 12/928,051

(22) Filed: Dec. 2, 2010

(51) Int. Cl. A01K 29/00

(52) U.S. Cl. 119/166

(57) ABSTRACT

My invention is an animal one piece lavatory with only curved angles that can be any size or color. The lavatory includes a single structure having a bottom with a slight curved edge angling up that may exist around its entire perimeter for holding a removable absorbent material for animal waste. The lavatory shall also include a backside that rises from the curved edge, then straight up to a desired height. The lavatory may also include one to two additional sides, either right or left, or both, that would rise like the backside from the curved edge. The lavatory single structure or an area of the structure will be made of an elastic material so the side or sides can be bent toward the bottom.

### BACKGROUND OF THE INVENTION

We, my wife, children and I lost a beautiful and loveable pet to an infection a few years ago from something he ate outside. We now have another pet that stays indoors and only goes out with us. The invention of a one piece only curved angled animal lavatory fills a long overdue need for all pet owners, who want to keep their pets indoors safe from diseases and pet owners who don't want to get up at night or go out in hot, cold, or inclement weather conditions so that their pets can relieve themselves. Also, this invention will be extremely beneficial to the elderly, disabled or for anyone who wants to keep or get a pet, but has trouble getting outside or maintaining a pet in the house.

The invention, an animal lavatory is different than the prior art in its field. It is a new structural design that allows for easy usability. It is a single one piece structure with only curved angles and curved edges with a bottom for holding removable absorbent material to hold animal waste and one to three sides, that has flexibility. The invention can be used by any animal, especially male animals that stand or raise their legs when relieving themselves. It can be made in any size so it can accommodate any size animal. The prior art in the field have sharp ninety degree angles that create corners that are hard to clean. The prior art also have hinges, fasteners, adornments, connectors, etc. and more than one part that also make it difficult to not only clean but keep sanitized and disease free. The prior art, because of its many piece, parts, and adornments, I believe creates a scary and confusing environment for the animals, who just want to relieve themselves, making the prior art less useful. I think animals are smarter than we think and simplicity with some conditioning psychology, animal training is all that is necessary for the animals to relieve themselves and use my simplistic invention.

The invention, because of its curved angles and one piece simple structural design will make it less expensive to manufacture and more affordable than the prior art in the field of the invention. The invention also can use any removable absorbent material to catch the animal waste also making it more affordable and easier to use. Also, a lot of municipalities require pet owners to clean up their pets waste after their pets relieve themselves on public streets. So my invention could also be used by those pet owners who wish to keep my invention in their yards outside to avoid having to carry to clean up devices around their streets to clean up their pet's waste and then carry the waste back to their house to dispose of it.

There is a plurality of prior art in the field of the invention and a few of them are U.S. Pat. No. 3,735,735 which is a portable commode for pets that has boxes, hinges, sections, legs, etc. and lots of other parts. Another prior art is a dog pan U.S. Pat. No. 1,773,141 that has hinges, adornments and additional objects like shrubs and sharp angles. And one more prior art, as an example here is a portable pet potty and wetting wall, U.S. Pat. No. 4,892,058, containing left and right troughs, positioning blocks, other parts, and sharp angles.

The invention will be made to be solid with some flexibility with heated liquid plastic or rubber or a combination of the two or a similar material in a heated mold or press or from sheet material in a heated press or mold or any other means that could create a monolithic structure or if necessary, two structures or more that could be combined to form a single one piece structure when finished.

The single one piece monolithic design of the invention may be the best embodiment for the invention. However, a possible embodiment of two pieces a bottom and a backside that can attach to form a single structure and unattached when desired with only curved edges and angles could also be acceptable.

### BRIEF DESCRIPTION OF THE DRAWINGS

FIG. 1 is a plain view of the animal lavatory showing a bottom with an curved edge and a backside according to the invention.

FIG. 2 is a plain view of the animal lavatory showing a bottom with an curved edge a backside and one additional side according to the invention.

FIG. 3 is a plain view of the animal lavatory showing a bottom with an curved edge a backside and two additional sides according to the invention.

FIG. 4 is a plain view of the animal lavatory showing a bottom with an curved edge only along the backside and a backside according to the invention.

FIG. 5 is a plain view of the animal lavatory showing a bottom with an curved edge only along the backside and the backside and one additional side according to the invention.

FIG. 6 is a plain view of the animal lavatory showing a bottom with an curved edge only along the backside and the backside and two additional sides according to the invention.

FIG. 7 is a plain view of the animal lavatory showing an curved groove at the base of the backside part and a bottom part with an curved edge all around the perimeter.

FIG. 8 is a plain view of the animal lavatory showing an curved groove at the base of the backside part and a bottom part with an curved edge only along the backside.

### DETAILED DESRIPTION OF THE DRAWINGS

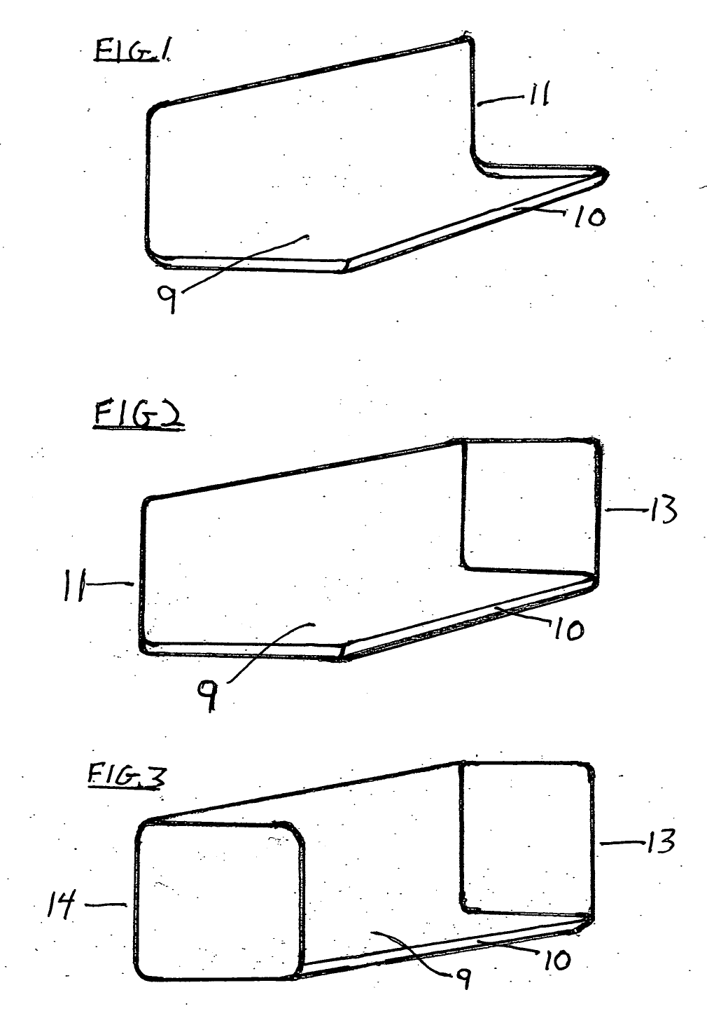

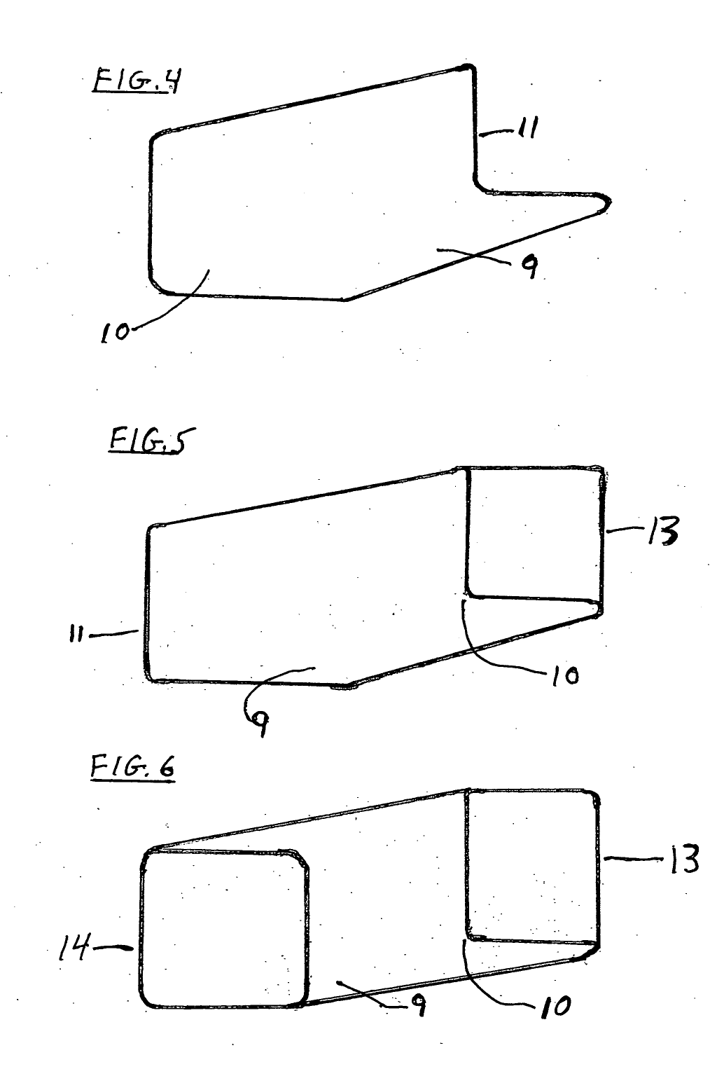

Referring to FIG. 1 shows number 9 a bottom with a 10 an curved edge rising up all along the 9 bottom's perimeter with a 11 backside rising up to a desired height form the 10 curved edge on that side. FIG. 2 shows a 9 bottom with a 10 an curved edge rising up all along the 9 bottom's perimeter with an 11 backside and one additional side either 13 right or left rising up to a desired height from the 10 curved edge on those sides. FIG. 3 shows a 9 bottom with 10 an curved edge rising up all along the 9 bottom's perimeter with an 11 backside and two additional sides both 13 right and 14 left rising up to a desired height from the 10 curved edge on those sides.

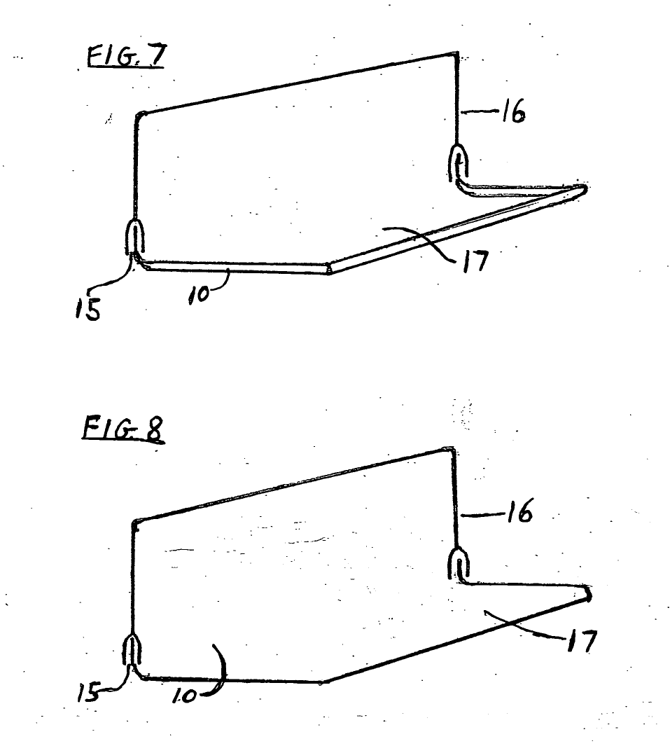

FIG. 4 shows a 9 bottom with a 10 curved edge only along the 11 backside that rises from the 10 an curved edge on that side to a desired height. FIG. 5 shows a 9 bottom with a 10 curved edge only along the 11 backside and one additional side either 13 right or left rising up from the 9 curved edge on those sides to a desired height. FIG. 6 shows a 9 bottom with a 10 an curved edge only along the 11 backside and two additional sides both 13 right and 14 left rising up from the 10 curved edge on those sides to a desired height.

FIG. 7 shows a 17 bottom part with a 10 curved edge rising up all along the 17 bottom part perimeter with a 16 backside part with a 15 curved groove at its base that can attach and unattached to the 10 curved edge on the 17 bottom part and the 16 backside can be any height. FIG. 8 shows a 17 bottom part with a 10 curved edge only along a 16 backside part with a 15 curved groove at its base that can attach and unattached to the 10 curved edge on the 17 bottom part and the 16 backside can be any height.

What is claimed is:

1. An animal one piece lavatory with only curved angles: comprising
a. single structure having a bottom with an curved edge angling up, for holding a removable absorbent material for animal waste, with a single backside that rises straight up to a desired height that has elasticity.

2. An animal lavatory according to claim 1 further including on additional side, either right or left.

3. An animal lavatory according to claim 1 further including two additional sides, both right and left.

4. An animal one piece lavatory with only curved angles: comprising
a. A single structure having a bottom for holding a removable absorbent material for animal waste with a curved angle rising only from the backside straight up to a desired height.

5. An animal lavatory according to claim 4 further including an curved angle only for the backside and one additional side, either right or left.

6. An animal lavatory according to claim 4 further including curved angles only for the backside and two additional sides, both right and left.

7. An animal two piece lavatory with only curved angles: comprising
a. A bottom part with an curved edge angling up for holding an removable absorbent material for animal waste and a backside part that rises straight up from the curved edge to a desired height that can be attachable and removable from the curved edge of the bottom part.

8. An animal two piece lavatory with only curved angles: comprising
a. A bottom part with a curved edge angling up from only the backside for holding a removable absorbent material and a backside part that rises straight up from the curved edge to a desired height that can be attached and removed from the curved edge of the bottom part.
